(19) United States
(12) Patent Application Publication
(10) Pub. No.: US 2006/0087287 A1
(43) Pub. Date: Apr. 27, 2006

(54) Voltage monitoring for connected electrical energy storage cells

(75) Inventor: Guy C. Thrap, Del Mar, CA (US)

Correspondence Address: Maxwell Technologies, Inc.;Att. Intellectual Property Dept., 9244 Balboa Ave., San Diego, CA, 92123, US

(73) Assignee: Maxwell Technologies, Inc.

(21) Appl. No.: 10/974,574

(22) Filed: Oct. 27, 2004

(51) Int. Cl. H02J 7/00

(52) U.S. Cl. 320/118

(57) ABSTRACT

A voltage monitoring circuit is connected to monitor voltage of fewer than all cells of a series stack of energy storage cells. The individual cell voltages in the stack are balanced using voltage equalizers, so that the voltage of any one cell or a combination of selected cells is indicative of the voltage of each individual cell in the stack. Monitoring the voltage of the selected cells can thus replace monitoring the individual cell voltages. The voltage monitoring circuit can be combined with one of the voltage equalizers. In one exemplary embodiment, each energy storage cell is a double layer capacitor cell.

### FIELD OF THE INVENTION

The present invention relates generally to circuits for charging and balancing voltages of energy storage cells connected in series stacks, and, more particularly, to circuit for monitoring voltages of individual rechargeable cells of a module.

### BACKGROUND

Energy storage devices are often constructed as individual cells connected in series. The series connected cells may be disposed within a module such that the module provides a nominal operating voltage higher than those available from each individual cell. When charging a module, different rates of accepting charge can cause some of the cells to have higher voltages than other cells. Similarly, individual cells may have different discharge characteristics and internal leakage currents, causing voltage differences on individual cells during discharge cycles and during periods of module inactivity (periods of storage, for example). Voltage differences across cells of the same module are problematic for at least the following two related reasons.

First, voltage differences can cause some cells to be charged to a higher than rated voltage. Excessive voltage (overvoltage) on a cell can shorten the cell's life, and, consequently, shorten the life of the module. Overvoltage can also cause catastrophic failure of the cell and, thus, the module. To avoid such failures, many manufacturers of modules provide a safety margin, with the maximum module voltage rating set below the sum of the voltage ratings of the constituent cells. This approach lowers the energy capacity of the module. Furthermore, voltage differences can accumulate during a module's service life, eventually causing overvoltage when the module is charged. Providing a reasonably small safety margin is therefore not a foolproof solution.

Second, overvoltage on some cells may cause lower than average voltage (undervoltage) in other cells. The cells with low voltages then accept less energy and are underutilized, also resulting in a lower stored energy capacity of the module.

It follows that, ideally, all cells of a module should be identical, so that the cells accept and release electrical charge at the same rate, and have voltages that closely track each other. In practice, however, cell characteristics may vary significantly from cell to cell. This is particularly true when the cells have not been “matched” to each other. Matching cells of a module is an additional step in a module manufacturing process, which increases the cost of a module. Moreover, the original match is hardly ever perfect; and the closer the specified match, the costlier the matching step becomes. Equally important, even closely-matched cells may age differently, with increasing divergence in their performance characteristics over both charge-discharge cycles and chronological age.

To reduce the problems associated with voltage imbalances of individual cells, some modules employ voltage balancers across the cells, also known as voltage equalizers. These devices help to keep the cell-to-cell voltage variations relatively low. Voltage equalizers known in the art include flyback circuits, shunt circuits, and switched capacitor circuits.

The presence of a voltage equalizer does not necessarily prevent cell overvoltage. For example, the entire module can still be overcharged, resulting in an overvoltage being equally distributed across all cells of the module. This is particularly true in case of a voltage equalizer that removes charge from cells with relatively high voltages and transfers the removed charge to the cells with relatively low voltages. Such is typically the case with some flyback circuit equalizers and switched capacitor equalizers.

In some applications, voltage monitoring circuits connected to each individual cell can be used to monitor individual cell voltages in order to reduce the possibility of cell overvoltage, as well as for other reasons. Voltage monitoring can be used alone, or in combination with voltage equalization. For example, some shunt voltage equalizers include voltage monitors that control parallel connections (shunts) across individual cells. When a cell's voltage exceeds some preset level, the shunt across that cell is activated, limiting current flowing into the cell, or draining current from the cell. But voltage monitoring in a voltage equalizer circuit is limited to a comparison against a single reference threshold. Moreover, known voltage equalizers do include voltage monitoring circuits for individual cells, and/or do not provide outputs for reading cell voltages. Therefore, a need arises to include a circuit for monitoring voltages of individual cells even in applications where a voltage equalizer is already present' but, providing a separate circuit for monitoring voltage of each individual cell can be rather expensive, especially in case of modules with a large number of cells.

Because a total module voltage can be much higher than the voltage of an individual cell, providing a single circuit for monitoring the total voltage of the module, i.e., the combined voltage of a series combination of cells, does not solve the problem of overvoltage of individual cells. For example, modules with 42- and 50-volt nominal outputs are already available or should soon become available. A circuit capable of monitoring a high module voltage would require components with relatively high voltage ratings, which adversely affects the cost of the monitoring circuits, their complexity, and precision.

Thus, it would be desirable to improve upon the limitations of the prior art.

### SUMMARY

A need thus exists for circuits that can be used to monitor voltages of each energy storage cell in a series combination of cells, but without the accompanying expense of building a separate circuit for each cell. Another need exists for circuits that can be used to monitor voltages of each energy storage cell in a module, and that do not require components rated for the total module voltage.

The present invention includes an electrical device that includes at least one voltage equalizer and a voltage monitoring circuit. The at least one voltage equalizer can be configured to balance individual cell voltages of a plurality of energy storage cells connected in series, and the voltage monitoring circuit can be configured to monitor voltage of a subset of the plurality of energy storage cells. The subset includes fewer than all cells of the plurality of energy cells. The device may further include the plurality of energy storage cells, such as double layer capacitor cells. In some exemplary embodiments, the voltage monitoring circuit provides one or more indications when the voltage of the subset of the cells crosses reference voltages. For example, the voltage monitoring circuit can provide a first indication when the voltage of the subset exceeds a first reference voltage, and provides a second indication when the voltage of the subset exceeds a second reference voltage. In other exemplary embodiments, the voltage monitoring circuit provides real-time indications of the voltage of the subset. The real-time indications can be provided continuously or continually, i.e., at some predefined time intervals.

In one embodiment, an electrical device comprises at least one voltage equalizer configured to balance individual cell voltages of a plurality of energy storage cells connected in series; and a voltage monitoring circuit configured to monitor voltage of a subset of the plurality of energy storage cells, wherein the subset comprises fewer than all cells of the plurality of energy cells. The voltage monitoring circuit may be capable of providing a first indication when the voltage of the subset crosses a first reference voltage. The voltage monitoring circuit may be further capable of providing a second indication when the voltage of the subset crosses a second reference voltage. The voltage monitoring circuit may be capable of providing a first indication when the voltage of the subset exceeds a first reference voltage. The voltage monitoring circuit may be further capable of providing a second indication when the voltage of the subset exceeds a second reference voltage. The voltage monitoring circuit may be capable of providing a real-time indication of the voltage of the subset. The voltage monitoring circuit may be capable of providing a real-time continual indication of the voltage of the subset. The voltage monitoring circuit may be capable of providing a real-time continuous indication of the voltage of the subset. The cells may provide energy for driving a vehicle, wherein the voltage monitoring circuit is capable of providing readings indicative of the voltage of the subset, the electrical device further comprising a circuit capable of transforming the readings into an estimate of remaining driving range of the vehicle. The at least one voltage equalizer may consist of a single voltage equalizer. The at least one voltage equalizer may comprise a plurality of voltage equalizers. The at least one voltage equalizer may comprise a first voltage equalizer; and the first voltage equalizer and the voltage monitoring circuit may be built as a single unit. Each voltage equalizer of the plurality of voltage equalizers may be configured to balance voltages of two adjacent cells of the plurality of energy storage cells. The plurality of energy storage cells may comprise more than two energy storage cells; and the voltage monitoring circuit may be configured to monitor voltage of exactly two energy storage cells. The voltage monitoring circuit may be powered by the voltage of the subset of the plurality of energy storage cells. The voltage monitoring circuit may be powered by voltage of fewer than all cells of the plurality of energy storage cells. The at least one voltage equalizer may have balancing capability at least an order of magnitude greater than imbalance introduced by current drawn by the voltage monitoring circuit. The at least one voltage equalizer may have balancing capability exceeding imbalance due to a sum of maximum design current drawn by the voltage monitoring circuit and maximum design imbalance that can arise in operation of the cells. The at least one voltage equalizer may comprise a shunt equalizer. The at least one voltage equalizer may comprise a flyback equalizer. The at least one voltage equalizer may comprise a switched capacitor equalizer. The at least one voltage equalizer may comprise an active balancer circuit. The at least one voltage equalizer may comprise a balancing circuit connected between a positive terminal of one energy storage cell and a negative terminal of a second energy storage cell.

In one embodiment, an electrical device comprises a plurality of energy storage cells connected in series; at least one voltage equalizer configured to balance individual cell voltages of the plurality of energy storage cells; and a voltage monitoring circuit configured to monitor voltage of a subset of the plurality of energy storage cells, wherein the subset comprises fewer than all cells of the plurality of energy cells. Each cell of the plurality of energy storage cells may comprise a double layer capacitor. The voltage monitoring circuit may be capable of providing a first indication when the voltage of the subset crosses a first reference voltage. The voltage monitoring circuit may be further capable of providing a second indication when the voltage of the subset crosses a second reference voltage. The voltage monitoring circuit may be capable of providing a first indication when the voltage of the subset exceeds a first reference voltage. The voltage monitoring circuit may be further capable of providing a second indication when the voltage of the subset exceeds a second reference voltage. The voltage monitoring circuit may be capable of providing a real-time indication of the voltage of the subset. The voltage monitoring circuit may be capable of providing a real-time continual indication of the voltage of the subset. The voltage monitoring circuit may be capable of providing a real-time continuous indication of the voltage of the subset. The voltage monitoring circuit may be capable of providing readings indicative of the voltage of the subset, the electrical device further comprising a circuit capable of transforming the readings into an estimate of remaining driving range of the vehicle. The at least one voltage equalizer may comprise a single voltage equalizer. The at least one voltage equalizer may comprise a plurality of voltage equalizers. The plurality of voltage equalizer may comprise a first voltage equalizer; and the first voltage equalizer and the voltage monitoring circuit may be built as a single unit. Each voltage equalizer of the plurality of voltage equalizers may be configured to balance voltages of two adjacent cells of the plurality of energy storage cells. The plurality of energy storage cells may comprise more than two energy storage cells; and the voltage monitoring circuit may be configured to monitor voltage of exactly two energy storage cells. The voltage monitoring circuit may be powered by the voltage of the subset of the plurality of energy storage cells. The voltage monitoring circuit may be powered by voltage of fewer than all cells of the plurality of energy storage cells. The at least one voltage equalizer may have balancing capability at least an order of magnitude greater than imbalance introduced by current drawn by the voltage monitoring circuit. The at least one voltage equalizer may have balancing capability exceeding imbalance due to a sum of maximum design current drawn by the voltage monitoring circuit and maximum design imbalances that can arise in operation of the cells. The at least one voltage equalizer may comprise a shunt equalizer. The at least one voltage equalizer may comprise a flyback equalizer. The at least one voltage equalizer may comprise a switched capacitor equalizer.

In one embodiment, a method comprises providing a plurality of energy storage cells connected in series; balancing individual cell voltages of the plurality of energy storage cells; and monitoring voltage of a subset of the plurality of energy storage cells, wherein the subset comprises fewer than all cells of the plurality of energy cells. The step of monitoring may comprise providing a first indication when the voltage of the subset crosses a first reference voltage. The step of monitoring may further comprise providing a second indication when the voltage of the subset crosses a second reference voltage. The step of monitoring may comprise providing a first indication when the voltage of the subset exceeds a first reference voltage. The step of monitoring may further comprise providing a second indication when the voltage of the subset exceeds a second reference voltage. The step of monitoring may comprise providing a real-time indication of the voltage of the subset. The step of monitoring may comprise providing a real-time continual indication of the voltage of the subset. The step of monitoring may comprise providing a real-time continuous indication of the voltage of the subset. The cells may provide energy for driving a vehicle, wherein the step of monitoring comprises providing readings indicative of the voltage of the subset, the method further comprising transforming the readings into an estimate of remaining driving range of the vehicle. The step of balancing may comprise using a single voltage equalizer to balance the individual cell voltages. The step of balancing may comprise using a plurality of voltage equalizers to balance the individual cell voltages. The step of monitoring may comprise using a voltage monitoring circuit; Therein the plurality of voltage equalizers comprises a first voltage equalizer; and wherein the first voltage equalizer and the voltage monitoring circuit are built as a single unit. The step of using may comprise utilizing each voltage equalizer of the plurality of voltage equalizers to balance voltages of two adjacent cells of the plurality of energy storage cells. The step of providing may comprise providing more than two energy storage cells; and the step of monitoring may comprise monitoring voltage of exactly two energy storage cells. The step of monitoring may comprise using a voltage monitoring circuit powered by the voltage of the subset of the plurality of energy storage cells. The step of monitoring may comprise using a voltage monitoring circuit powered by voltage of fewer than all cells of the plurality of energy storage cells. The step of balancing may comprise using a voltage equalizer with balancing capability at least an order of magnitude greater than imbalance introduced by current drawn of the voltage monitoring circuit. The step of balancing may comprise using a voltage equalizer with balancing capability exceeding imbalance due to a sum of imbalance caused by maximum design current drawn by the voltage monitoring circuit and maximum design imbalance that can arise in operation of the cells. The step of balancing may comprise using a shunt equalizer. The step of balancing may comprise using a flyback equalizer. The step of balancing may comprise using a switched capacitor equalizer. Each energy storage cell of the plurality of energy storage cells may comprise a double layer capacitor.

These and other features and aspects of the present invention will be better understood with reference to the following description, drawings, and appended claims.

### BRIEF DESCIRPTION OF THE FIGURES

FIG. 1 is a high-level illustration of a combination of a series stack of energy storage cells, voltage equalizers, and a voltage monitoring circuit, in accordance with an embodiment of the invention;

FIG. 2 is a high-level illustration of another combination of a series stack of energy storage cells, voltage equalizers, and a voltage monitoring circuit, in accordance with an embodiment of the invention;

FIG. 3 illustrates selected components of a voltage equalizer and a voltage monitoring circuit, in accordance with an embodiment of the invention; and

FIG. 4 is a high-level illustration of a combination of a series stack of energy storage cells, a multi-cell voltage equalizer, and a voltage monitoring circuit, in accordance with an embodiment of the invention.

### DETAILED DESCRIPTION

Reference will now be made in detail to several embodiments of the invention that are illustrated in the accompanying drawings. Same or similar reference numerals may be used in the drawings and the description to refer to the same or like parts. The drawings are in a simplified form and not to precise scale. For purposes of convenience and clarity only, directional terms such as top, bottom, left, right, up, down, over, above, below, beneath, rear, and front may be used with respect to the accompanying drawings. These and similar directional terms should not be construed to limit the scope of the invention in any manner.

In this description, the words “embodiment” and “variant” refer to particular apparatus or process, and not necessarily to the same apparatus or process. Thus, “one embodiment” (or a similar expression) used in one place or context can refer to a particular apparatus or process; the same or a similar expression in a different place can refer to a different apparatus or process. The expression “alternative embodiment” and similar phrases are used to indicate one of a number of possible embodiments. The number of possible embodiments is not limited. The words “couple,” “connect,” and similar terms with their inflectional morphemes are used interchangeably, unless the difference is noted or otherwise made clear from the context. These words and expressions do not necessarily signify direct connections, but include connections through mediate components and devices. The word “module” can also used interchangeably with other terminology used by those skilled in the art to signify multiple energy storage cells coupled in series. Additional definitions and clarifications may be interspersed in the text of this document.

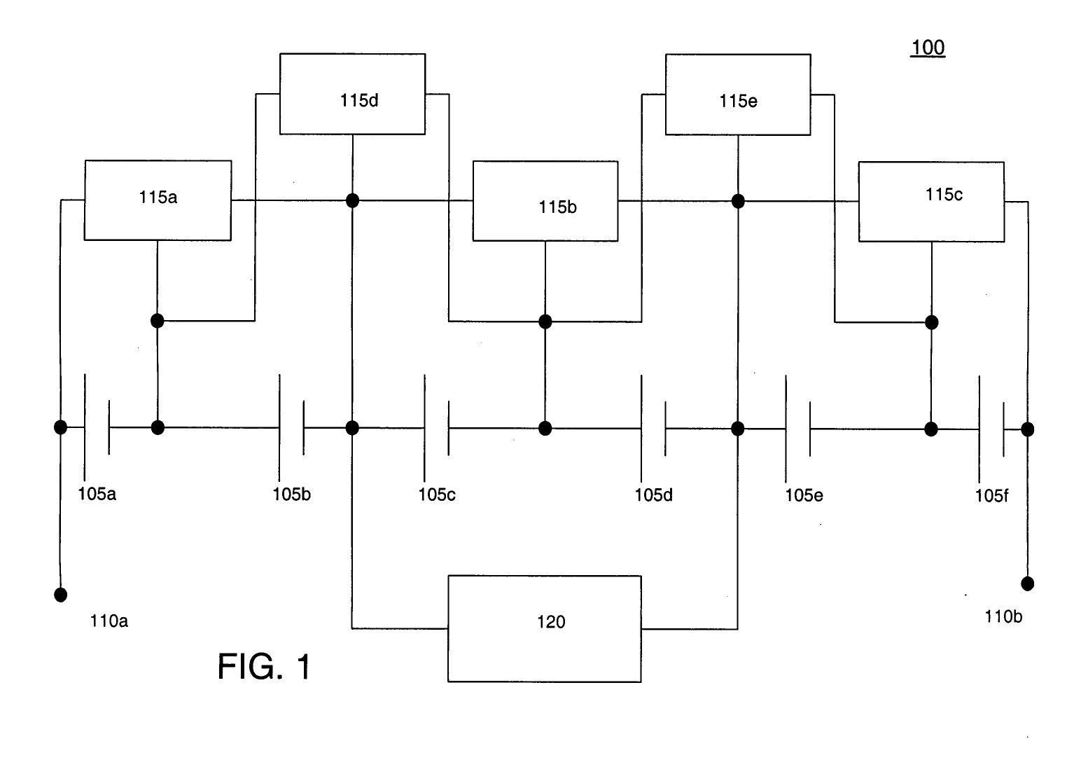

FIG. 1 is a high-level illustration of a combination 100 of a series stack of energy storage cells, voltage equalizers, and a voltage monitoring circuit. In the Figure, six energy storage cells 105A through 105F are connected in series between a positive terminal 110A and a negative terminal 110B, so that the potential difference between the terminals 110A and 110B is approximately equal to six times the voltage of each individual cell 105. Voltage equalizers 115A, 115B, and 115C are coupled to the series stack of the cells 105 and operate to bring the voltages of the cells 105 into approximate parity with each other. A voltage monitoring circuit 120 is coupled across the series combination of the cells 105C and 105D to monitor the combined voltage of these two cells.

As a person skilled in the art would recognize after perusal of this document, the invention is not limited to applications with six energy storage cells, but can include fewer or more than six cells.

In one embodiment, each cell 105A through 105F is a double layer capacitor. (Double layer capacitors are also known as “ultracapacitors” and “supercapacitors” because of their high capacitance in relation to weight and volume.) In alternative embodiments, the invention can be applied to voltage monitoring of energy storage cells manufactured using other technologies, for example, conventional capacitors, and secondary (rechargeable) cells such as lead acid, nickel cadmium (NiCad), nickel metal hydrate (NiMH), lithium ion, and lithium polymer cells. This list is representative and is not intended to be exclusive.

In normal operation, the voltage equalizers 115 function to balance the voltages of the individual cells 105. Each equalizer can include, for example, a shunt equalizer circuit, a flyback equalizer circuit, a switched capacitor circuit, or an active balancing circuit as described in US Patent #########, filed #####, which is incorporated herein by reference.

As has been mentioned above, a shunt equalizer may utilize a shunt connection across each cell; the shunt connection is activated when the cell's voltage exceeds some preset level. When activated, the shunt connection can divert some or all of the current flowing into the cell, or drain current from the cell. In this way, a shunt equalizer may prevent a further rise in a cell's voltage, or may lower a cell's voltage.

A flyback equalizer may include a transformer with a primary winding and a plurality of substantially identical secondary windings. Each secondary winding is connected across one of the individual cells. To prevent the cells from discharging through their associated windings, diodes are inserted in series with the windings. A power source for charging the series stack of cells is then connected to the primary winding through a switch. The state of the switch is controlled by an alternating signal from an oscillator. With the switch in the closed state, current flows through the primary winding, and magnetic energy is stored in the transformer's core. When the oscillator causes the switch to open, the magnetic energy “flies” through the secondary windings into individual cells. Because the windings are magnetically coupled, more energy flows into the cells with relatively low voltages than into cells with higher voltages. Continually opening and closing the switch thus brings the individual cell voltages into approximate balance.

In a switched capacitor equalizer, a capacitor may be switched back and forth between two states. In a first state, the capacitor is coupled across one of two neighboring energy cells of a series stack. In a second state, the capacitor is coupled across the second of the two cells. The capacitor is charged by the cell with the higher voltage, and then discharges into the cell with the lower voltage. When the capacitor states are switched at a sufficient rate, the voltages of the two cells are brought to substantially the same voltage and maintained in such state.

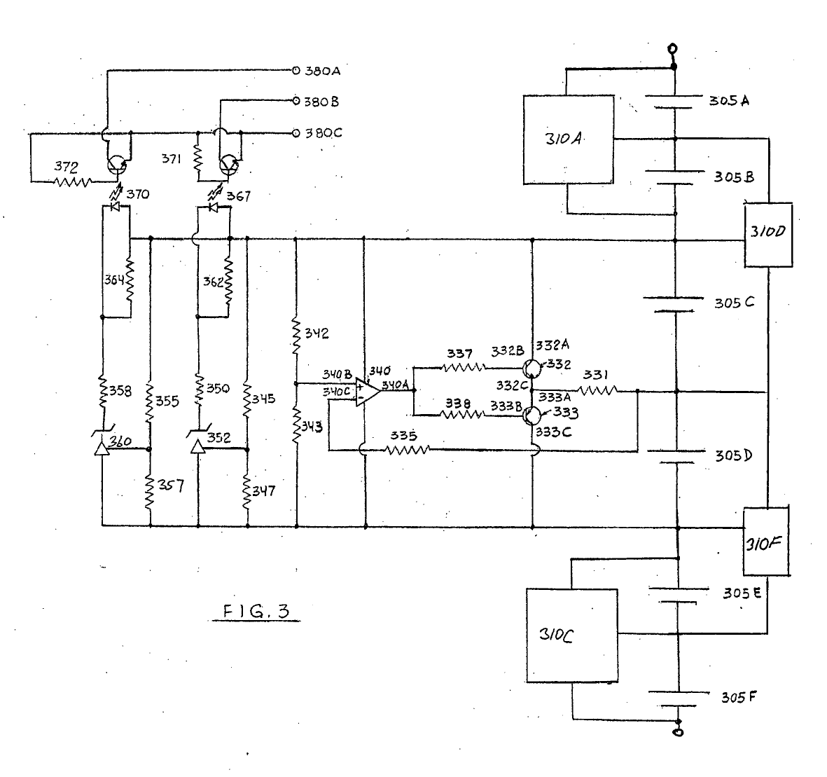

Turning next to the voltage monitoring circuit 120, this circuit can be implemented in a variety of ways. In some embodiments, the voltage monitoring circuit 120 provides a simple indication when the monitored voltage exceeds a predetermined or dynamically set threshold. In other embodiments, the circuit 120 provides plural indications corresponding to plural thresholds. (One such embodiment will be described below with reference to FIG. 3.) The circuit 120 or a control circuit coupled to it can automatically cause certain actions to be taken when the monitored voltage exceeds or falls below a threshold. For example, the circuit 120 can turn on and off a charger connected to the stack of the cells 105 through the terminals 110. In other embodiments, the circuit 120 provides a continuous or continual real-time indication of actual voltage appearing on the monitored cells. The indication can be an analog or digitized voltage reading, or a voltage reading mapped to another variable that can be more readily interpreted by a user. In an electric or hybrid vehicle, for example, the voltage reading can be transformed into an estimate of remaining driving range.

Note that because the voltage monitoring circuit 120 is connected across only two cells (105C and 105D) of the series combination of cells 105, its components generally need not have voltage ratings much in excess of twice the rating of each cell 105. Thus, the need for higher rated components can be avoided. At the same time, the voltage monitoring circuit 120 in effect monitors the voltages on each cell 105 of the series cell stack. This conclusion follows because of the presence of the voltage equalizers 115, which operate to bring the voltages of all the individual cells into approximate voltage parity.

The voltage monitoring circuit 120 does consume some electricity, but the energy for its operation comes from all the cells 105A through 105F (and/or from the charging circuit that may be connected to the terminals 120). As long as the voltage equalizers 105 are capable of transferring charge in excess of that consumed by the circuit 120, the voltages of the individual cells 105 will remain balanced. Indeed, in a typical application, the imbalance that can be potentially introduced by the voltage monitoring circuit 120 would be at least an order of magnitude smaller than the balancing capability of the voltage equalizers 115. In one particular embodiment, the balancing capability of the voltage equalizers 115 exceeds the sum of the maximum design current consumed by the circuit 120 and the maximum design imbalances that can potentially arise in operation of the cells 105.

Note that the voltage monitoring circuit 120 need not be connected exactly in the center of the stack of the cells 105. To the contrary, the circuit 120 can be connected anywhere in the stack, including at either end of the stack. Because the voltages on the individual cells are balanced by the equalizers 115, the readings or other indications provided by the circuit 120 should not vary significantly with the specific position. Similarly, the voltage monitoring circuit 120 can be connected across any number of the cells in the stack, including a single cell.

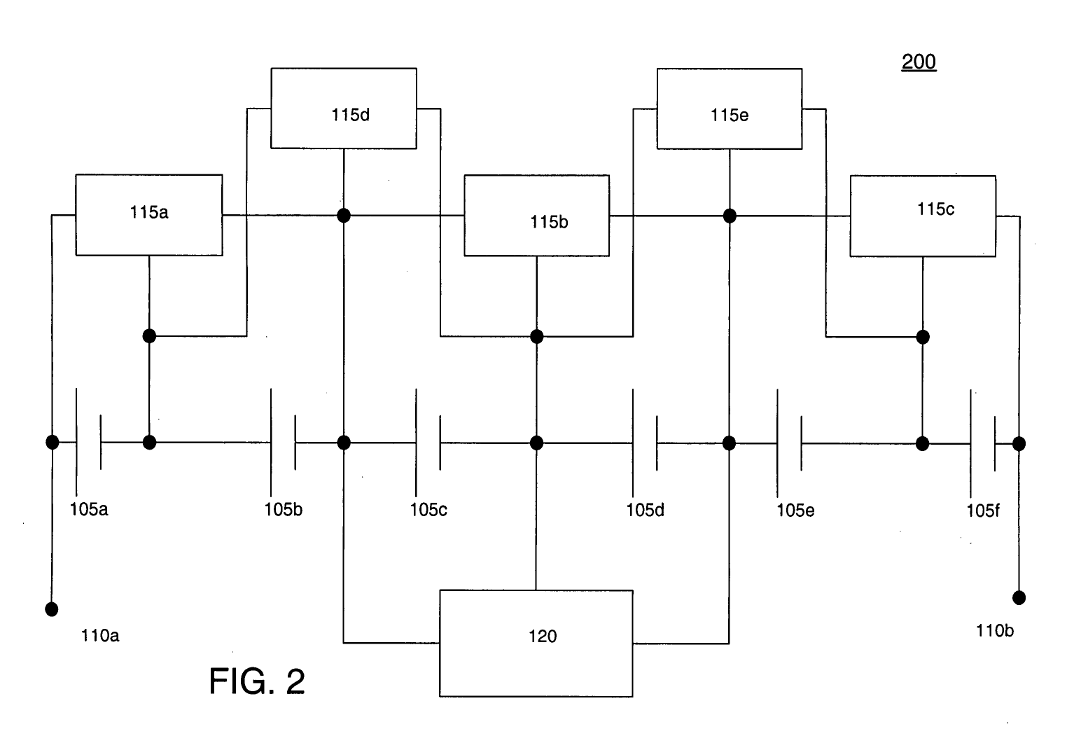

The voltage monitoring circuit 120 can draw electric current for its operation from the same voltage source as is monitored by the circuit 120. In an alternative embodiment, illustrated in FIG. 2, the circuit 120 draws current from two adjacent cells 105C and 105D, but monitors voltage of a single cell (105C or 105D). The combination 200 of FIG. 2 includes, in addition to the elements illustrated in FIG. 1, a connection between the voltage monitoring circuit 120 and the junction between the cells 105C and 105D.

In some embodiments, a voltage monitoring circuit is implemented together with one of the voltage equalizers. FIG. 3 illustrates one such embodiment 300. Six energy storage cells 305A through 305F are arranged as a series stack forming a module. A voltage equalizer 310A balances the voltages of the cells 305A and 305B, while a voltage equalizer 310C balances the voltages of the cells 305E and 305F; similar functionality is provided by voltage equalizers 310D and 310F. Most of the remaining components shown in the Figure are used to provide voltage equalization of and to monitor the voltages of cells 305C and 305D.

Resistors 342 and 343 form a voltage divider across the cells 305C and 305D. The voltage divider biases a non-inverting input 340B of a voltage comparing device 340. Because the nominal values of these two resistors are the same, the bias voltage at the input 340B is the average of the voltages of the cells 305C and 305D. Expressing this in algebraic notation, we get

$${V}_{340 B} = \frac{( {V}_{305 C} + {V}_{305 D} )}{2} .$$

(Note that here and in the following discussion voltages are referenced to the level on the negative side of the cell 305D.) The inverting input 340C of the voltage comparing device 340 is connected through a current limiting resistor 335 to the common junction of the cells 305C and 305D, so that the voltage at the inverting input 340C is essentially the same as the voltage of the cell 305D, i.e., V_{340C}=V_{305D}. It follows that the output 340A of the device 340 is driven high when the voltage of the cell 305D is less than the average voltage of the cells 305C and 305D, and driven low in the opposite case. Because the voltage of the cell 305D is less than the average voltage of the cells 305C and 305D only when he voltage of the cell 305D is less than that of 305C, the output of the device 340 is driven high and low depending on the relative voltages of the two cells. In other words,

(1) V_{340A} is high when V_{305C}>V_{305D}, and

(2) V_{340A} is low when V_{305C}<V^{305D}.

When V_{340A} is high, it forward-biases (through a resistor 337) the base-emitter junction of a switching transistor 332, turning the transistor 332 ON. A switching transistor 333 remains in the OFF state because its base-emitter junction is not forward biased. The transistor 332 shunts (through a current limiting resistor 331) the cell 305C, lowering the cell's voltage.

When V_{340A} is low, the states of the transistors 332 and 333 reverse: the transistor 332 is turned OFF, while the transistor 333 is turned ON (through a resistor 338), shunting the cell 305D and lowering the cell's voltage.

In this way, the transistors 332 and 333, the voltage comparing device 340, and the resistors 331, 335, 337, 338, 342, and 343 operate as a voltage equalizer that balances the voltages of the cells 305C and 305D.

Turning next to the voltage monitoring function, the circuit 300 is designed to generate a first signal when the combined voltage of the cells 305C and 305D exceeds a first level, and a second signal when the combined voltage exceeds a second level. The voltage comparisons are carried out by adjustable precision regulators 352 and 360, each connected in a voltage monitoring configuration. A voltage divider formed by resistors 345 and 347 biases a reference input of the precision regulator 352. When the voltage appearing on this reference input is less than a voltage provided by an internal reference of the regulator 352, the regulator 352 is in the non-conducting OFF state. Current does not flow through a resistor 362 or between anode and cathode of a phototransistor/optocoupler 367. Consequently, the optocoupler 367 remains in the OFF state, and the open collector output at a terminal 380B remains in a high impedance state. Conversely, when the voltage on the reference input of the regulator 352 exceeds the internal reference voltage, the regulator 352 turns to the conducting ON state, drawing current through the resistor 362 and between the anode and cathode of the optocoupler 367. The optocoupler 367 then turns ON, and the terminal 380B transitions to a low impedance (ground) state.

Note that the voltage at the reference input of the regulator 352 depends directly on the voltage driving the voltage divider formed by the resistors 345 and 347, i.e., on the combined voltage of the cells 305C and 305D. The regulator 352, optocoupler 367, and the resistors surrounding these devices thus effectively function as a voltage monitoring circuit that provides an output activated when the voltage of the two cells exceeds a first level determined by the internal reference voltage of the regulator 352, and by the ratio of the resistors 345 and 347.

The operation of a second precision regulator 360, second phototransistor/optocoupler 370, and resistors surrounding these devices parallels the operation of the regulator 352, optocoupler 367, and their resistors. These devices effectively function as a second voltage monitoring circuit that provides an open collector output at a terminal 380A that is activated when the combined voltage of the cells 305C and 305D exceeds a second level. The second level is determined by the internal reference voltage of the regulator 360, and by the ratio of resistors 355 and 357.

Table 1 below provides values or part numbers for most components of one possible embodiment of circuit 300.

TABLE 1

| # | Component Reference Designation | Value or Part Number |
|---|---|---|
| 1 | Transistors 332 and 333 | MMBT2222AWT1 |
| 2 | Voltage Comparing Device 340 | TLV2211CDBV |
| | | (Micropower Operational |
| | | Amplifier) |
| 3 | Adjustable Precision | TL431/SO |
| | Regulators 352 and 360 | |
| 4 | Resistor 331 | 5.6 Ω |
| 5 | Resistors 337 and 338 | 28 Ω |
| 6 | Resistor 335 | 49.9 KΩ |
| 7 | Resistors 342 and 343 | 100 KΩ |
| 8 | Resistor 345 | 26.7 KΩ |
| 9 | Resistors 347 and 357 | 24.9 KΩ |
| 10 | Resistors 350 and 358 | 240 Ω |
| 11 | Resistor 355 | 28 KΩ |
| 12 | Resistors 362 and 364 | 1 KΩ |
| 13 | Resistors 371 and 372 | 1 MΩ |
| 14 | Phototransistors/ | CNY17-3 |
| | optocouplers 367 and 370 | |

Using components and values of Table 1, let us now calculate the voltage thresholds at which the outputs at the terminals 380A and 380B are activated. From the above discussion it follows that the first voltage threshold (which activates the output 380B) is reached when the voltage at the junction of the resistors 345 and 347 is equal to the voltage of the internal reference of the regulator 352. Assuming that the voltages of the cells 305C and 305D are substantially the same (each equal to V_{cell}), we obtain the following equation:

$$( \frac{2 \cdot {V}_{cell} \cdot {R}_{347}}{{R}_{345} + {R}_{347}} ) = {V}_{ref} ,$$

where R₃₄₅ and R₃₄₇ designate resistance values of the resistors 345 and 347, respectively, and V_{ref} is the internal reference voltage of the regulator 352.

Rearranging the terms, we obtain the following equation from which V_{cell} at the first threshold (V_{T1}) can be calculated:

$${V}_{T 1} = \frac{{V}_{ref} \cdot ( {R}_{345} + {R}_{347} )}{2 \cdot {R}_{347}} .$$

When the average voltage of the cells 305C and 305D reaches V_{T1}, output at the terminal 380B is activated. Similarly, output at the terminal 380A is activated when the average cell voltage reaches a second threshold voltage (V_{T2}), which can be computed from the following formula:

$${V}_{T 2} = \frac{{V}_{ref} \cdot ( {R}_{355} + {R}_{357} )}{2 \cdot {R}_{357}} .$$

The nominal internal reference of the TL431/SO devices used in the regulators 352 and 360 is listed as 2.495 volts. Substituting this value and the values of the resistors given in Table 1, above, we obtain:

$${V}_{T 1} = \frac{2.495 \cdot ( 26.7 + 24.9 )}{2 \cdot 24.9} \approx 2.585 volts , and$$

$${V}_{T 1} = \frac{2.495 \cdot ( 28 + 24.9 )}{2 \cdot 24.9} \approx 2.650 volts .$$

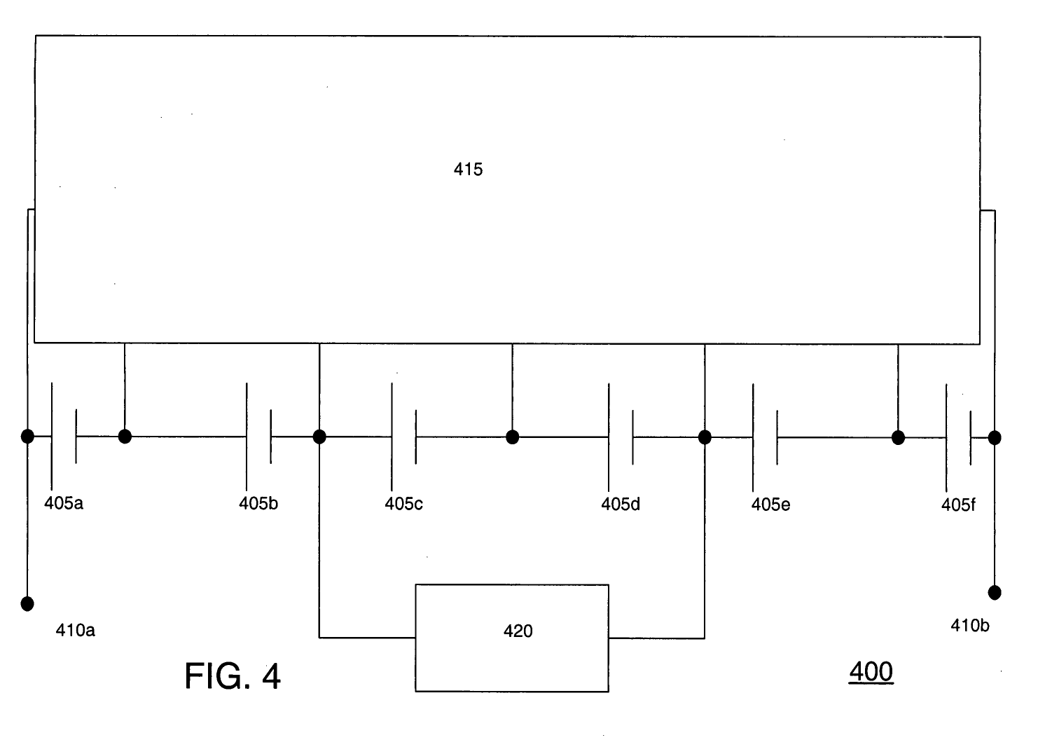

Although FIGS. 1-3 illustrate voltage balancer as separate devices, this is not a requirement of the invention. Indeed, multiple balancers can be advantageously built as a single device. FIG. 4 illustrates a combination 400 of a stack of energy storage cells 405, a multi-cell voltage balancer 415, and a voltage monitoring circuit 420.

This document describes in some detail inventive circuits and methods for monitoring voltages of stacks of cells connected in series. This was done for illustration purposes. Neither the specific embodiments of the invention as a whole, nor those of its features limit the general principles underlying the invention. In particular, the invention is not limited to the specific circuits and/or components described, and/or applications thereof. The specific features described herein may be used in some embodiments, but not in others, without departure from the spirit and scope of the invention as set forth. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protections afforded the invention, which function is served by the claims and their legal equivalents.

I claim:

1. An electrical device comprising:
at least one voltage equalizer configured to balance individual cell voltages of a plurality of energy storage cells connected in series; and
a voltage monitoring circuit configured to monitor voltage of a subset of the plurality of energy storage cells, wherein the subset comprises fewer than all cells of the plurality of energy cells.

2. An electrical device according to claim 1, wherein the voltage monitoring circuit is capable of providing a first indication when the voltage of the subset crosses a first reference voltage.

3. An electrical device according to claim 2, wherein the voltage monitoring circuit is further capable of providing a second indication when the voltage of the subset crosses a second reference voltage.

4. An electrical device according to claim 1, wherein the voltage monitoring circuit is capable of providing a first indication when the voltage of the subset exceeds a first reference voltage.

5. An electrical device according to claim 4, wherein the voltage monitoring circuit is further capable of providing a second indication when the voltage of the subset exceeds a second reference voltage.

6. An electrical device according to claim 1, wherein the voltage monitoring circuit is capable of providing a real-time indication of the voltage of the subset.

7. An electrical device according to claim 1, wherein the voltage monitoring circuit is capable of providing a real-time continual indication of the voltage of the subset.

8. An electrical device according to claim 1, wherein the voltage monitoring circuit is capable of providing a real-time continuous indication of the voltage of the subset.

9. An electrical device according to claim 1, wherein the cells provide energy for driving a vehicle, the voltage monitoring circuit is capable of providing readings indicative of the voltage of the subset, the electrical device further comprising a circuit capable of transforming the readings into an estimate of remaining driving range of the vehicle.

10. An electrical device according to claim 1, wherein the at least one voltage equalizer consists of a single voltage equalizer.

11. An electrical device according to claim 1, wherein the at least one voltage equalizer comprises a plurality of voltage equalizers.

12. An electrical device according to claim 11, wherein:
the at least one voltage equalizer comprises a first voltage equalizer; and
the first voltage equalizer and the voltage monitoring circuit are built as a single unit.

13. An electrical device according to claim 11, wherein each voltage equalizer of the plurality of voltage equalizers is configured to balance voltages of two adjacent cells of the plurality of energy storage cells.

14. An electrical device according to claim 1, wherein:
the plurality of energy storage cells comprises more than two energy storage cells; and
the voltage monitoring circuit is configured to monitor voltage of exactly two energy storage cells.

15. An electrical device according to claim 1, wherein the voltage monitoring circuit is powered by the voltage of the subset of the plurality of energy storage cells.

16. An electrical device according to claim 1, wherein the voltage monitoring circuit is powered by voltage of fewer than all cells of the plurality of energy storage cells.

17. An electrical device according to claim 16, wherein the at least one voltage equalizer has balancing capability at least an order of magnitude greater than imbalance introduced by current drawn by the voltage monitoring circuit.

18. An electrical device according to claim 16, wherein the at least one voltage equalizer has balancing capability exceeding imbalance due to a sum of maximum design current drawn by the voltage monitoring circuit and maximum design imbalance that can arise in operation of the cells.

19. An electrical device according to claim 16, wherein the at least one voltage equalizer comprises a shunt equalizer.

20. An electrical device according to claim 16, wherein the at least one voltage equalizer comprises a flyback equalizer.

21. An electrical device according to claim 16, wherein the at least one voltage equalizer comprises a switched capacitor equalizer.

22. An electrical device according to claim 1, further comprising:
the plurality of energy storage cells connected in series.

23. An electrical device according to claim 22, wherein each cell of the plurality of energy storage cells comprises a double layer capacitor.

24. An electrical device according to claim 1, wherein the voltage monitoring circuit comprises an optically isolated output at which the voltage can be measured.

25. An electrical device according to claim 16, wherein the at least one voltage equalizer comprises at least one active balancing circuit.

26. An electrical device according to claim 25, wherein the at least one active balancing circuit is connected to a positive terminal of one energy storage cell and a negative terminal of a second energy storage cell.

27. A method comprising:
providing a plurality of energy storage cells connected in series;
balancing individual cell voltages of the plurality of energy storage cells; and
monitoring voltage of a subset of the plurality of energy storage cells, wherein the subset comprises fewer than all cells of the plurality of energy cells.

28. A method according to claim 27, wherein the cells provide energy for driving a vehicle.

29. A method according to claim 27, wherein the step of balancing comprises using a plurality of voltage equalizers to balance the individual cell voltages.

31. A method according to claim 29, wherein:
the step of monitoring comprises using a voltage monitoring circuit;
the plurality of voltage equalizers comprises a first voltage equalizer; and
the first voltage equalizer and the voltage monitoring circuit are built as a single unit.

32. A method according to claim 27, wherein the step of monitoring comprises using a voltage monitoring circuit powered by voltage of fewer than all cells of the plurality of energy storage cells.

33. A method according to claim 29, wherein the step of balancing comprises using a shunt equalizer.

34. A method according to claim 29, wherein the step of balancing comprises using a flyback equalizer.

35. A method according to claim 29, wherein the step of balancing comprises using a switched capacitor equalizer.

36. A method according to claim 29, wherein the step of balancing comprises using an active balancing circuit.

37. A method according to claim 27, wherein each energy storage cell of the plurality of energy storage cells comprises a double layer capacitor.

38. An electrical device, comprising:
cell voltage balancing means for balancing cell voltages of a plurality of energy storage cells; and
cell voltage monitoring means for monitoring a voltage of the energy storage cells.

39. The device according to claim 38, wherein the energy storage cells comprise double-layer capacitors.
